(19) United States
(12) Patent Application Publication
(10) Pub. No.: US 2020/0036107 A1
(43) Pub. Date: Jan. 30, 2020

(54) CONDUCTIVE WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Takeshi SHIMIZU, Yokkaichi (JP); Hirotaka BABA, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/496,122

(22) PCT Filed: Mar. 8, 2018
(86) PCT No.: PCT/JP2018/009103

§ 371 Date: Sep. 20, 2019

(30) Foreign Application Priority Data
Mar. 22, 2017 (JP) 2017-055824

(51) Int. Cl. H01R 4/20; H01R 4/18; H01R 4/58; H01R 4/72; H01R 4/60; H01R 43/048

(52) U.S. Cl. CPC H01R 4/20; H01R 4/183; H01R 43/048; H01R 4/72; H01R 4/60; H01R 4/58

(57) ABSTRACT

A conductive wire configured to be inserted into an electromagnetic shield provided in a wire harness to be routed in a vehicle, and to electrically connect electric apparatuses, the conductive wire including: a flexible conductor; a columnar conductor arranged to be coaxial with the flexible conductor; and a tube into which the flexible conductor and the columnar conductor are inserted, wherein the flexible conductor and the columnar conductor are configured to be electrically connected to the electric apparatuses, and a protrusion that protrudes toward the columnar conductor and electrically connects the flexible conductor to the columnar conductor is provided on an inner circumferential surface of the tube to extend in a circumferential direction over an entire inner circumferential surface.

### BACKGROUND

The present invention relates to a conductive wire.

Conventionally, as shown in JP 2011-173456A, vehicles such as hybrid vehicles and electric automobiles include a motor serving as a motive power source for travel by the vehicle, an inverter connected to the motor, and a high-voltage battery for supplying electric power to the inverter, and the inverter and the high-voltage battery are connected to each other using a plurality of conductive wires.

Conductive wires used in a wire harness disclosed in JP 2011-173456A are inserted into a shield pipe made of metal that is arranged underneath the floor of a vehicle, for example. The shield pipe is bent into a shape that follows a predetermined wiring path, and its front end portion is introduced into the engine room until it reaches the vicinity of the inverter. Since the wiring path between the shield pipe and the inverter is relatively short and the connection task is difficult if the shield pipe cannot be freely bent, a metal braided portion that is formed by braiding metal strands into a tubular shape is connected to the front end of the shield pipe so that bending can be easily performed. Similarly, the conductive wires inside the metal braided portion are also required to follow the bending of the metal braided portion, and therefore, stranded electric wires that have excellent bendability are commonly used over the entire wiring path as the conductive wires for connecting the battery and the motor (inverter).

### SUMMARY

The diameter of the shield pipe depends on the outer diameter of the conductive wires to be inserted into the shield pipe. However, it is difficult to achieve a smaller diameter with a flexible conductor such as a stranded electric wire, and therefore, the changing over of the conductor to a columnar conductor (single-core wire), whose diameter can be easily reduced, has recently been considered for the portion to be inserted into the shield pipe.

However, while free bending of the electric wires is required in the portion outside of the shield pipe as described above, this requirement cannot be easily met with a columnar conductor. For this reason, flexible conductors need to be used in the portion outside of the shield pipe. Therefore, the columnar conductor is connected to the flexible conductor at the exit portion of the shield pipe. Moreover, an insulating coating such as a heat shrinkable tube needs to be placed over the connection portion where the two conductors are connected to each other, in order to avoid short circuiting between the conductors.

Here, it is conceivable that electrical connection between the flexible conductor and the columnar conductor can be achieved by welding the conductors, for example. However, when one of the conductors is placed on the other in the radial direction and welded thereto, a stepped portion in the radial direction occurs in the connection portion where the conductors are connected to each other, and there is a risk that the insulating coating will be torn by an edge of the stepped portion.

An exemplary aspect of the disclosure provides a conductive wire in which the stepped portion in the radial direction can be minimized in the connection portion where the flexible conductor and the columnar conductor are connected to each other.

A conductive wire according to an exemplary aspect includes a flexible conductor, a columnar conductor arranged to be coaxial with the flexible conductor, and a tube into which the flexible conductor and the columnar conductor are inserted, wherein a protrusion that protrudes toward the columnar conductor and electrically connects the flexible conductor to the columnar conductor is provided on an inner circumferential surface of the tube to extend in a circumferential direction over the entire inner circumferential surface.

With this configuration, the flexible conductor and the columnar conductor are electrically connected to each other by the protrusion of the tube in a state in which the flexible conductor and the columnar conductor are coaxially arranged, thus making it possible to minimize the stepped portion in the radial direction in the connector where the conductors are connected to each other compared with a case where the conductors are merely brought into contact with each other in the radial direction.

In the above-mentioned conductive wire, it is preferable that a portion of the tube provided with the protrusion has an outer diameter that is smaller than that of a portion of the tubular member not provided with the protrusion.

With this configuration, the portion of the tube provided with the protrusion has an outer diameter that is smaller than that of a portion of the tube not provided with the protrusion. That is, the protrusion can be formed by reducing the diameter of the tube through plastic working.

In the above-mentioned conductive wire, it is preferable that the flexible conductor is brought into contact with and electrically connected to the columnar conductor by the protrusion in a state in which an end portion of the columnar conductor is inserted into an end of the flexible conductor.

With this configuration, the flexible conductor is brought into contact with and electrically connected to the columnar conductor by the protrusion in a state in which an end of the columnar conductor is inserted into an end of the flexible conductor, which can contribute to an improvement in the reliability of the connection.

In the above-mentioned conductive wire, it is preferable that the flexible conductor is a tubular braid formed by conductive strands.

With this configuration, the flexible conductor is formed by a tubular braide, and the columnar conductor can thus be easily inserted into the flexible conductor.

In the above-mentioned conductive wire, it is preferable that the columnar conductor and the tubular braid as well as an electrical connector where the columnar conductor and the tubular braided member are electrically connected to each other are collectively covered by an insulating cover.

With this configuration, the columnar conductor and the tubular braid as well as the electrical connection portion where the columnar conductor and the tubular braid are electrically connected to each other are collectively covered, thus making it possible to suppress an increase in the number of components.

With the conductive wire of the present invention, the stepped portion in the radial direction can be minimized in the connector where the flexible conductor and the columnar conductor are connected to each other.

### BRIEF DESCRIPTION OF THE DRAWINGS

FIG. 1 is a schematic configuration diagram of a wire harness of a first embodiment.

FIG. 2 is a cross-sectional view of a conductive wire of the first embodiment.

FIGS. 3(a), 3(b), and 3(c) are schematic cross-sectional views for describing a method of producing the conductive wire of the first embodiment.

FIG. 4 is a cross-sectional view of a conductive wire of a second embodiment.

FIGS. 5(a), 5(b), and 5(c) are schematic cross-sectional views for explaining a method of producing the conductive wire of the second embodiment.

FIG. 6 is a cross-sectional view of a conductive wire of a modified example.

### DETAILED DESCRIPTION OF EMBODIMENTS

### First Embodiment

Hereinafter, a first embodiment of a wire harness will be described with reference to the drawings. It should be noted that a portion of the configuration may be exaggerated or simplified for illustrative reasons in the diagrams. In addition, the ratios between the dimensions shown in the diagrams may be different from the ratios between the actual dimensions.

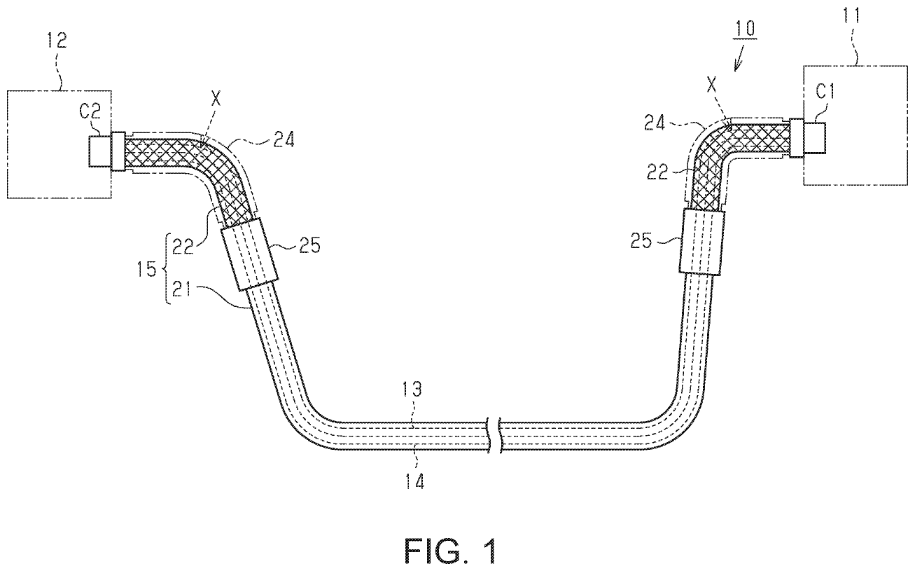

As shown in FIG. 1, a wire harness 10 of this embodiment is routed in a hybrid vehicle, an electric automobile, or the like so as to pass under the floor of the vehicle, etc. in order to connect a high-voltage battery 11, which is an electric apparatus, provided in a rear portion of the vehicle to an inverter 12, which is an electric apparatus, provided in a front portion of the vehicle, for example. The inverter 12 is connected to a wheel driving motor (not shown), which is a motive power source for travel by the vehicle, generates alternating current power from direct current power received from the high-voltage battery 11, and supplies the alternating current power to the motor. The high-voltage battery 11 is a battery that is capable of supplying a voltage of several hundred volts.

The wire harness 10 includes two high-voltage electric wires 13 and 14 that are conductive wires to be respectively connected to a positive terminal and a negative terminal of the high-voltage battery 11, which is an electric apparatus, and a tubular electromagnetic shield portion 15 that collectively surrounds the high-voltage electric wires 13 and 14.

The electromagnetic shield portion 15 has an elongated tubular shape as a whole. The intermediate portion of the electromagnetic shield portion 15 in the longitudinal direction is constituted by a metal pipe 21, and portions including two end portions in the longitudinal direction other than the portion constituted by the metal pipe 21 are each constituted by a braided member 22.

The metal pipe 21 is made of an iron-based metal material or an aluminum-based metal material, for example. The metal pipe 21 is to be routed so as to pass under the floor of the vehicle, and is bent into a predetermined shape that corresponds to the configuration of the region under the floor. The metal pipe 21 collectively shields the high-voltage electric wires 13 and 14 inserted thereinto, and protects the high-voltage electric wires 13 and 14 from flying stones and the like.

The braided members 22 are tubular members obtained by braiding a plurality of metal strands. The braided members 22 are coupled to the two end portions in the longitudinal direction of the metal pipe 21 using coupling members (not shown) such as crimping rings, and the braided members 22 are thus electrically connected to the metal pipe 21. The braided members 22 are surrounded by sheathing members 24 such as corrugated tubes, for example. Rubber grommets 25 are attached to the connection portions where the metal pipe 21 and the braided members 22 are connected to each other so as to cover the connection portions and prevent the intrusion of water.

Each of the braided members 22 collectively surrounds portions of the high-voltage electric wires 13 and 14 that extend out from an end portion of the metal pipe 21 (portions X outside of the pipe). The braided member 22 electromagnetically shields the portions X of the high-voltage electric wires 13 and 14 outside of the pipe.

As shown in FIG. 1, the high-voltage electric wires 13 and 14 are inserted into the electromagnetic shield portion 15. The end portions on one side of the high-voltage electric wires 13 and 14 are connected to the high-voltage battery 11 via a connector C1, and the end portions on the other side are connected to the inverter 12 via a connector C2.

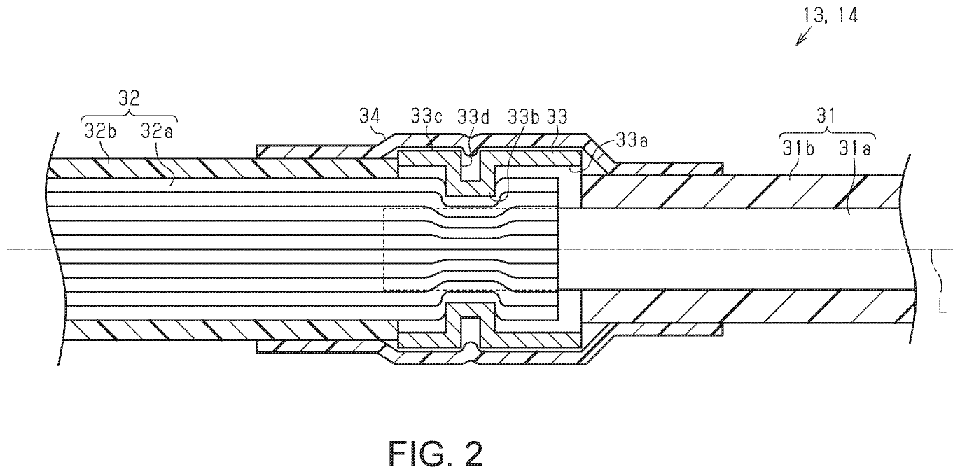

As shown in FIG. 2, each of the high-voltage electric wires 13 and 14 of this embodiment includes a single-core wire 31, which is a columnar conductor, a stranded electric wire 32, which is a flexible conductor, and a tubular member 33.

The single-core wire 31 includes (is constituted by) a single conductor 31a that has a solid structure with a substantially cylindrical shape, and a coating 31b serving as an insulating coating of the conductor 31a. The single-core wire 31 is made of aluminum or an aluminum alloy, for example. The conductor 31a of the single-core wire 31 is configured such that one end portion thereof is exposed from the coating 31b. The coating 31b can be constituted by a heat shrinkable tube, for example.

The stranded electric wire 32 includes a core wire 32a constituted by a plurality of strands, and a coating 32b that covers the core wire 32a and is made of an insulating material. The core wire 32a is constituted by strands made of aluminum or an aluminum alloy, for example. The core wire 32a is configured such that one end portion thereof is exposed from the coating 32b and the end portion of the single-core wire 31 is inserted into the exposed portion. That is, a state in which the single-core wire 31 is inserted into the core wire 32a is realized. This results in a configuration in which the stranded electric wire 32 and the single-core wire 31 are coaxially arranged (along an axis L).

The tubular member 33 is conductive, and is made of aluminum or an aluminum alloy, for example. The tubular member 33 is provided such that the core wire 32a of the stranded electric wire 32 and the conductor 31a of the single-core wire 31 are sheathed with the tubular member 33. This embodiment is configured such that the tubular member 33 is brought into contact with the coating 32b of the stranded electric wire 32 in a direction extending along the axis L, and the coating 32b of the stranded electric wire 32 is not sheathed with the tubular member 33. Accordingly, the inner diameter of the tubular member 33 can be reduced compared with a configuration in which the coating 32b of the stranded electric wire 32 is sheathed with the tubular member 33, for example, which can contribute to a reduction in size (diameter) of the tubular member 33.

The tubular member 33 includes a protrusion 33b that protrudes inward in the radial direction from an inner circumferential surface 33a of the tubular member 33. The protrusion 33b is provided extending in the circumferential direction over the entire inner circumferential surface 33a of the tubular member 33. The protrusion 33b presses and holds the stranded electric wire 32 (core wire 32a) between the tubular member 33 and the single-core wire 31 (conductor 31a). The core wire 32a of the stranded electric wire 32 is thus brought into contact with and electrically connected to the conductor 31a of the single-core wire 31.

Here, the protrusion 33b is formed using a method in which a jig and the tubular member 33 to be processed are rotated relative to each other around the axis L while the jig is brought into contact with the tubular member 33 from the outside, and the tubular member 33 is thus plastically deformed to reduce its diameter. Examples of such a method include a spinning processing method and a swaging processing method. More specifically, the core wire 32a of the stranded electric wire 32 is arranged between the tubular member 33 and the conductor 31a of the single-core wire 31, and the diameter is reduced using the above-described method to form the protrusion 33b. Therefore, a groove 33d extending in the circumferential direction over the entire outer circumferential surface 33c of the tubular member 33 is formed at a position corresponding to the protrusion 33b. That is, a portion of the tubular member 33 provided with the protrusion 33b has an outer diameter that is smaller than that of a portion of the tubular member 33 not provided with the protrusion 33b. The protrusion 33b of this embodiment is formed such that the amount of protrusion from the inner circumferential surface 33a is substantially constant in the circumferential direction, and the tubular member 33 is arranged extending along the axis L.

In the high-voltage electric wires 13 and 14 of this embodiment, a substantially tubular insulating cover 34 that has insulating properties is provided at the portion where the single-core wire 31 and the stranded electric wire 32 are electrically connected to each other by the tubular member 33, so as to cover that portion and its surrounding region. For example, a heat shrinkable tube, which is shrunk by heat, is used as the insulating cover 34 and is attached, in a shrunk state, to the portion where the single-core wire 31 and the stranded electric wire 32 are electrically connected to each other by the tubular member 33. This prevents the portion where the single-core wire 31 and the stranded electric wire 32 are electrically connected to each other by the tubular member 33 from coming into contact with other members (conductive members), and short circuiting is thus prevented.

Next, a method for connecting the single-core wire 31 and the stranded electric wire 32, which are included in the high-voltage electric wires 13 and 14 of the wire harness 10 of this embodiment, will be described.

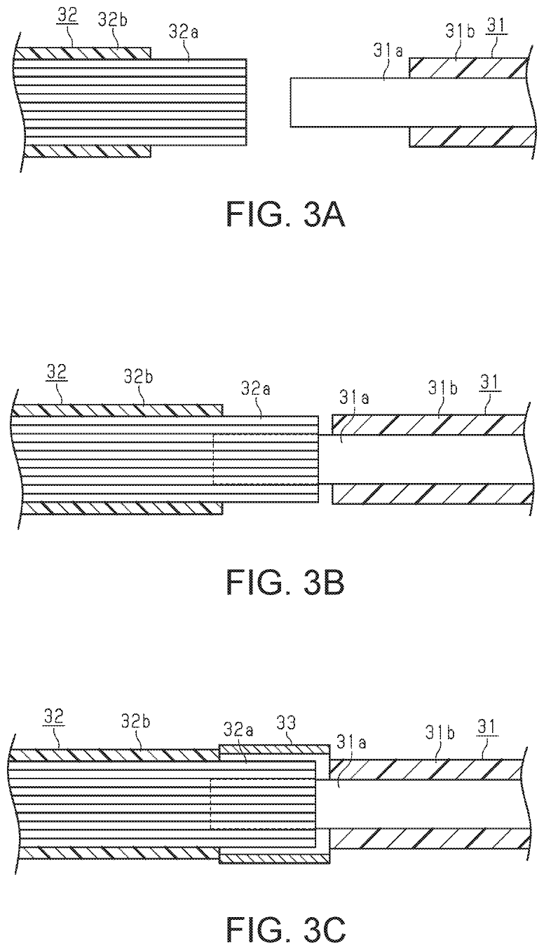

As shown in FIG. 3(a), the stranded electric wire 32 with a portion of the core wire 32a exposed from the coating 32b, and the single-core wire 31 with a portion of the conductor 31a exposed from the coating 31b are prepared.

As shown in FIG. 3(b), the core wire 32a of the stranded electric wire 32 is loosened, and the conductor 31a of the single-core wire 31 is inserted thereinto. That is, the conductor 31a of the single-core wire 31 is sheathed with the core wire 32a of the stranded electric wire 32.

As shown in FIG. 3(c), the portion where the conductor 31a of the single-core wire 31 is sheathed with the core wire 32a of the stranded electric wire 32 is sheathed with the tubular member 33.

Then, the tubular member 33 and a jig (not shown) are rotated relative to each other, the protrusion 33b is thus formed on the inner circumferential surface 33a of the tubular member 33 by the jig, and the core wire 32a of the stranded electric wire 32 is brought into contact with and electrically connected to the conductor 31a of the single-core wire 31 by the protrusion 33b. Then, the insulating cover 34 is placed over the tubular member 33, and the high-voltage electric wires 13 and 14 shown in FIG. 2 are thus completed.

Next, the functions of this embodiment will be described.

In the high-voltage electric wires 13 and 14 of the wire harness 10 of this embodiment, the protrusion 33b is provided on the inner circumferential surface 33a by reducing the diameter of a portion of the tubular member 33 in a state in which the core wire 32a of the stranded electric wire 32 is located between the tubular member 33 and the conductor 31a of the single-core wire 31. This protrusion 33b is configured to protrude from the inner circumferential surface 33a of the tubular member 33 toward the core wire 32a of the stranded electric wire 32, that is, inward in the radial direction. Accordingly, the core wire 32a of the stranded electric wire 32 is pressed and held between the protrusion 33b and the conductor 31a of the single-core wire 31, and the core wire 32a of the stranded electric wire 32 is thus electrically connected to the conductor 31a of the single-core wire 31.

Since the conductor 31a is inserted into the core wire 32a in a state in which the single-core wire 31 (conductor 31a) and the stranded electric wire 32 (core wire 32a) are coaxially arranged along the axis L, the level difference between the conductor 31a and the core wire 32a is reduced compared with a case where one of the conductor 31a and the core wire 32a is placed on the other in the radial direction.

Next, the effects of this embodiment will be described.

(1) The core wire 32a of the stranded electric wire 32 is electrically connected to the conductor 31a of the single-core wire 31 by the protrusion 33b of the tubular member 33 in a state in which the core wire 32a of the stranded electric wire 32 and the conductor 31a of the single-core wire 31 are coaxially arranged along the axis L. Therefore, the stepped portion in the radial direction in the connection portion where the conductor 31a and the core wire 32a are connected to each other can be minimized compared with a case where the conductor 31a and the core wire 32a are merely brought into contact with each other in the radial direction. Accordingly, breakage of the insulating cover 34 is suppressed.

(2) The portion of the tubular member 33 provided with the protrusion 33b has an outer diameter that is smaller than that of the portion of the tubular member 33 not provided with the protrusion 33b. That is, the protrusion 33b can be formed by reducing the diameter of the tubular member 33 through plastic working.

(3) The core wire 32a of the stranded electric wire 32 is brought into contact with and electrically connected to the conductor 31a of the single core wire 31 by the protrusion 33b in a state in which an end portion of the conductor 31a is inserted into an end portion of the core wire 32a, which can contribute to an improvement in the reliability of the connection.

### Second Embodiment

Hereinafter, a second embodiment of a wire harness will be described with reference to the drawings. It should be noted that a portion of the configuration may be exaggerated or simplified for illustrative reasons in the diagrams. In addition, the ratios between the dimensions shown in the diagrams may be different from the ratios between the actual dimensions. In this embodiment, configurations similar to those in the above-described first embodiment are denoted by the same reference numerals, and a portion or all of descriptions thereof are omitted.

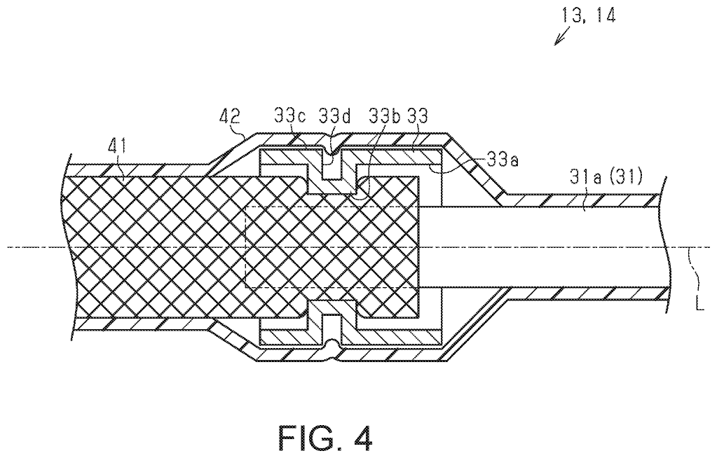

As shown in FIG. 4, this embodiment differs from the above-described first embodiment in that tubular braided members 41 are used as flexible conductors for the high-voltage electric wires 13 and 14 included in the wire harness 10. Moreover, this embodiment employs a configuration in which the single-core wire 31 only includes the conductor 31a, that is, the coating 31b is omitted.

The braided members 41 are tubular members obtained by braiding a plurality of metal strands. The braided member 41 is constituted by strands made of aluminum or an aluminum alloy. The conductor 31a is inserted into the braided member 41. At this time, a configuration in which the conductor 31a and the braided member 41 are coaxially arranged along the axis L is obtained.

The braided member 41 is pressed by the protrusion 33b of the tubular member 33 between the protrusion 33b and the conductor 31a, and the braided member 41 is brought into contact with and electrically connected to the single-core wire 31.

In the high-voltage electric wires 13 and 14 of this embodiment, a substantially tubular insulating cover 42 that has insulating properties is provided at the portion where the single-core wire 31 and the braided member 41 are electrically connected to each other by the tubular member 33, so as to cover that portion and its surrounding region. For example, the insulating cover 42 is constituted by a heat shrinkable tube, which is shrunk by heat. The insulating cover 42 is configured to collectively cover the braided member 41 and the single-core wire 31, and covers the entire braided member 41 in the longitudinal direction and the entire single-core wire 31 in the longitudinal direction. Accordingly, there is no need to individually coat the conductor 31a of the single-core wire 31 and the braided member 41 with insulating coatings, thus making it possible to suppress an increase in the number of components and an increase in man-hours. It should be noted that a configuration may be employed in which an end portion of the braided member 41 is not covered with the insulating cover 42 in order to connect the end portion to another member (e.g., connector).

Next, a method for connecting the single-core wire 31 and the braided member 41, which are included in the high-voltage electric wires 13 and 14 of the wire harness 10 of this embodiment, will be described.

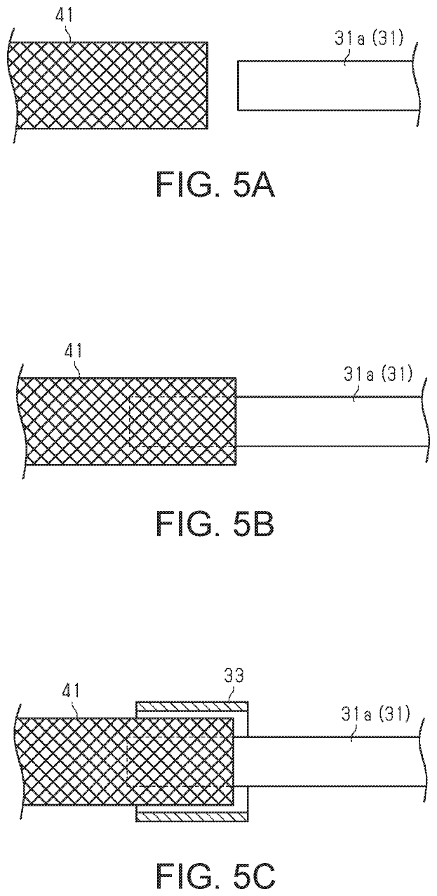

As shown in FIG. 5(a), the tubular braided member 41 and the single-core wire 31 with a portion of the conductor 31a exposed from the coating 31b are prepared.

As shown in FIG. 5(b), the conductor 31a of the single-core wire 31 is inserted into the tubular braided member 41. That is, the conductor 31a of the single-core wire 31 is sheathed with the braided member 41.

As shown in FIG. 5(c), the portion where the conductor 31a of the single-core wire 31 is sheathed with the tubular braided member 41 is sheathed with the tubular member 33.

Then, the tubular member 33 and a jig (not shown) are rotated relative to each other, the protrusion 33b is thus formed on the inner circumferential surface 33a of the tubular member 33 by the jig, and the braided member 41 is brought into contact with and electrically connected to the conductor 31a of the single-core wire 31 by the protrusion 33b. Then, the insulating cover 42 is placed over the braided member 41 and the conductor 31a as well as the outer circumferential surface 33c of the tubular member 33, and the high-voltage electric wires 13 and 14 shown in FIG. 4 are thus completed.

Next, the functions of this embodiment will be described.

In the high-voltage electric wires 13 and 14 of the wire harness 10 of this embodiment, the protrusion 33b is provided on the inner circumferential surface 33a by reducing the diameter of a portion of the tubular member 33 in a state in which the tubular braided member 41 is located between the tubular member 33 and the conductor 31a of the single-core wire 31. This protrusion 33b is configured to protrude from the inner circumferential surface 33a of the tubular member 33 toward the braided member 41, that is, inward in the radial direction. Accordingly, the braided member 41 is pressed and held between the protrusion 33b of the tubular member 33 and the conductor 31a of the single-core wire 31, and the braided member 41 is thus electrically connected to the conductor 31a of the single-core wire 31.

This embodiment exhibits the following effects in addition to the effects (1) to (3) of the above-described embodiment.

(4) The tubular braided member 41 is used as the flexible conductor, and the conductor 31a of the single-core wire 31 can thus be easily inserted into the braided member 41.

(5) Processing for stripping the coating or the like can be omitted unlike a case where the stranded electric wire is employed

(6) The single-core wire 31 (conductor 31a) and the tubular braided member 41 as well as the electrical connection portion where the single-core wire 31 and the braided member 41 are electrically connected to each other are collectively covered by the insulating cover 42, and therefore, coating can be performed while an increase in the number of components and an increase in man-hours are suppressed.

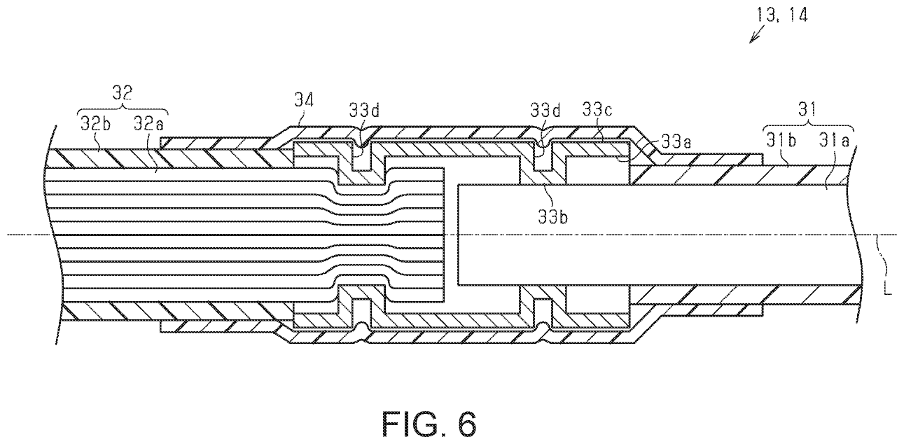

It should be noted that the above-described embodiments may be modified as follows.
Although the above-described embodiments are configured such that the flexible conductor (the stranded electric wire 32 in the first embodiment, and the tubular braided member 41 in the second embodiment) is brought into contact with and thus electrically connected to the conductor 31a of the single-core wire 31, there is no limitation to this configuration. For example, a configuration may be employed in which the flexible conductor and the columnar conductor are electrically connected to each other via the tubular member 33. A configuration shown in FIG. 6 is conceivable as an example of such a configuration.

As shown in FIG. 6, the conductor 31a of the single-core wire 31 and the core wire 32a of the stranded electric wire 32 are spaced apart from each other in the direction extending along the axis L, and are not mechanically in contact with each other. Two protrusions 33b that are spaced apart from each other in the direction extending along the axis L are provided on the inner circumferential surface 33a of the tubular member 33, and one of the protrusions 33b is brought into contact with the core wire 32a of the stranded electric wire 32 while the other of the protrusions 33b is brought into contact with the conductor 31a of the single-core wire 31. The core wire 32a of the stranded electric wire 32 and the conductor 31a of the single-core wire 31 are thus electrically connected to each other via the tubular member 33 (protrusions 33b).
Although not specifically stated in the above-described embodiments and the modified example shown in FIG. 6, a configuration may also be employed in which the protrusion 33b crushes the conductor 31a when the protrusion 33b is formed in the tubular member 33.
Although a swaging processing method and a spinning processing method are cited as examples of a method for processing (forming) the protrusion 33b in the above-described embodiments, there is no limitation thereto. The processing method can be changed as appropriate as long as the protrusion 33b extending in the circumferential direction over the entire tubular member 33 can be formed.
Although a configuration is employed in which the tubular member 33 is in contact with the end of the coating 32b of the stranded electric wire 32 in the longitudinal direction (direction extending along the axis L) in the above-described embodiments, a configuration may also be employed in which they are spaced apart from each other.

Moreover, a configuration may also be employed in which the tubular member 33 is placed on the coating 32b.
Although a configuration is employed in which shrinkable tubes are used as the insulating covers 34 and 42 in the above-described embodiments, there is no limitation thereto.
Although the tubular member 33 is made of aluminum or an aluminum alloy in the above-described embodiments, the tubular member 33 may also be made of a conductive material other than aluminum and aluminum alloys. The tubular member 33 may also be made of a non-conductive material (e.g., resin).
Although the high-voltage battery 11 and the inverter 12 are employed as the electric apparatuses to which the high-voltage electric wires 13 and 14 are connected in the above-described embodiments, there is no limitation thereto. For example, the high-voltage electric wires 13 and 14 may be used as electric wires that connect the inverter 12 and a wheel driving motor. That is, the high-voltage electric wires 13 and 14 can be used as electric wires for electrically connecting electric apparatuses installed in a vehicle.
The above-described embodiments and modified examples may be combined as appropriate.

The high-voltage electric wire 13 or 14 is an example of an electric wire assembly including first and second conductive wires (31a and 32a) that differ from each other in at least one of physical properties (bending flexibility, thickness, and the like). The tubular member 33 is an example of a conductive wire coupler configured to electrically connect the first and second conductive wires (31a and 32a) and position the first and second conductive wires (31a and 32a) coaxially and in series. The protrusion 33b of the tubular member 33 is an example of an annular clamp portion.

The present disclosure encompasses the following implementation examples. Reference numerals of constituent elements of the embodiments have been added not to limit the invention, but to assist comprehension. Supplementary Note 1: An electric wire assembly (13) according to some implementation examples includes first and second conductive wires (31a and 32a) that differ from each other in at least one of physical properties, and a conductive wire coupler (33) configured to position the first and second conductive wires (31a and 32a) coaxially and in series and electrically connect a conductive terminal portion of the first conductive wire (31a) and a conductive terminal portion of the second conductive wire (32a), wherein the conductive wire coupler (33) includes at least one annular clamp portion (33b) for compressing the conductive terminal portion of the second conductive wire (32a) inward in the radial direction.

Supplementary Note 2: In some implementation examples, the conductive terminal portion of the second conductive wire (32a) covers the conductive terminal portion of the first conductive wire (31a) over a certain length from the outside in the radial direction.

Supplementary Note 3: In some implementation examples, the at least one annular clamp portion (33b) of the conductive wire coupler (33) is provided at a position at which the conductive terminal portion of the second conductive wire (32a) is placed on the conductive terminal portion of the first conductive wire (31a), and is configured to press the conductive terminal portion of the second conductive wire (32a) against the conductive terminal portion of the first conductive wire (31a).

Supplementary Note 4: In some implementation examples, the at least one annular clamp portion (33b) of the conductive wire coupler (33) includes first and second annular clamp portions that are provided at different positions in the axial direction.

Supplementary Note 5: In some implementation examples, the first annular clamp portion is provided to be in direct contact with the conductive terminal portion of the first conductive wire (31a) and compress this conductive terminal portion inward in the radial direction, and the second annular clamp portion is provided to be in direct contact with the conductive terminal portion of the second conductive wire (32a) and compress this conductive terminal portion inward in the radial direction.

Supplementary Note 6: In some implementation examples, the conductive terminal portion of the first conductive wire (31a) and the conductive terminal portion of the second conductive wire (32a) are lined up in a row in the axial direction and are spaced apart from each other with a predetermined gap, and the at least one annular clamp portion (33b) of the conductive wire coupler (33) positions the first conductive wire (31a) and the second conductive wire (32a) in the axial direction to maintain the predetermined gap.

It will be appreciated by a person skilled in the art that the present invention may also be realized in another specific mode that does not depart from the technical idea. For example, some of the components described in the embodiments (or one or more aspects) may be omitted, or several components may be combined. The scope of the present invention is to be defined with reference to the appended claims, along with the full scope of equivalents to which the claims are entitled.

1. A conductive wire configured to be inserted into an electromagnetic shield provided in a wire harness to be routed in a vehicle, and to electrically connect electric apparatuses, the conductive wire comprising:
a flexible conductor;
a columnar conductor arranged to be coaxial with the flexible conductor; and
a tube into which the flexible conductor and the columnar conductor are inserted,
wherein the flexible conductor and the columnar conductor are configured to be electrically connected to the electric apparatuses, and
a protrusion that protrudes toward the columnar conductor and electrically connects the flexible conductor to the columnar conductor is provided on an inner circumferential surface of the tube to extend in a circumferential direction over an entire inner circumferential surface.

2. The conductive wire according to claim 1,
wherein a portion of the tube provided with the protrusion has an outer diameter that is smaller than that of a portion of the tubular member not provided with the protrusion.

3. The conductive wire according to claim 1,
wherein the flexible conductor is brought into contact with and electrically connected to the columnar conductor by the protrusion in a state in which an end of the columnar conductor is inserted into an end of the flexible conductor.

4. The conductive wire according to claim 1,
wherein the flexible conductor is a tubular braid formed by conductive strands.

5. The conductive wire according to claim 4,
wherein the columnar conductor and the tubular braid as well as an electrical connector where the columnar conductor and the tubular braid are electrically connected to each other are collectively covered by an insulating cover.
